(19) United States
(12) Patent Application Publication
(10) Pub. No.: US 2005/0181696 A1
(43) Pub. Date: Aug. 18, 2005

(54) Process for producing continuous filament nonwoven fabric

(75) Inventors: Valeria Griep Erdos, Porto Alegre (BR); Pierre D. Grondin, Mooresville, NC (US); Paul A. Kamnikar, Midvale, UT (US)

Correspondence Address: WOOD, PHILLIPS, KATZ, CLARK & MORTIMER;Citicorp Center, Suite 3800, 500 West Madison Street, Chicago, IL, 60661-2511, US

(73) Assignee: Polymer Group, Inc., North Charleston, SC (US)

(21) Appl. No.: 11/108,290

(22) Filed: Apr. 18, 2005

Related U.S. Application Data
(62) Division of application No. 10/245,830, filed on Sep. 17, 2002.
Application No. 10/245,830 is a continuation of application No. 10/062,055, filed on Feb. 1, 2002, now abandoned.
(60) Provisional application No. 60/266,154, filed on Feb. 2, 2001.

(51) Int. Cl. B32B 1/00; D04H 1/00; C04B 33/32; B28B 1/00; B29C 43/22; D04H 5/00; D04H 3/00; B29C 41/24; C04B 35/64; C04B 33/36; B28B 5/00; B28B 3/00; D04H 13/00; B29C 39/14; B28B 11/18; B29D 7/00

(52) U.S. Cl. 442/414; 428/220; 264/165; 264/639; 264/640

(57) ABSTRACT

The present invention is directed to a process for producing continuous filament nonwoven fabric which comprises the steps of providing a single polymeric resin having an MFR of between about 6 to 16, spinning said single polymeric resin using commercially available continuous filament spinning equipment, to yield a continuous filament nonwoven fabric exhibiting a tensile strength improvement of at least 30% when compared to similar resin of greater than 35 MFR.

### CROSS-REFERENCE TO RELATED APPLICATION

This application is a division of application Ser. No. 10/245,830, filed Sep. 17, 2002, which is a continuation of U.S. Ser. No. 10/062,055, filed Feb. 1, 2002, and which claims the priority of 60/266,154 filed Feb. 1, 2001, the disclosures of which are incorporated herein by reference.

### TECHNICAL FIELD

The present invention is directed to a process for producing continuous filament nonwoven fabric which comprises the steps of providing a single polymeric resin having an MFR of between about 6 to 16, spinning said single polymeric resin using commercially available spinning equipment, to yield a continuous filament nonwoven fabric exhibiting a tensile strength improvement of at least 30% over conventional practices.

### BACKGROUND OF THE INVENTION

Continuous filament nonwoven fabrics are typically formed by extrusion of polymeric resins through a spinneret assembly, which creates a plurality of continuous polymeric filaments. The filaments are then quenched and drawn, and collected to form a nonwoven web. The usual method for forming the collected web of continuous filaments into a useful product is to stabilized the web by thermal point bonding.

Processes are well known in the art, and are commercially available, for producing spunbond fabric of polypropylene polymeric resin. Two typical processes are known as the “Lurgi Process” and the “Reifenhauser Process”.

The Lurgi process is based on the extrusion of molten polymer through spinneret orifices followed by the newly formed extruded filaments being quenched with air and drawn by suction through venturi tubes. Subsequent to formation, the filaments are disbursed (mechanically or pneumatically) on a conveyor to form a nonwoven web. The nonwoven web is then stabilized by passing the web layer through the rolls of a thermal calender. One of these rollers typically has a smooth surface, while the other has an embossed surface. The embossed roll has small, raised areas that contact the nonwoven web, compressing it against the surface of the smooth roll. At these compression points, the filaments are at least partially melted and become bonded to each other. The raised surfaces on the embossed roll typically represent from about 13% to 25% of the total surface area.

The Reifenhauser process differs from the Lurgi process in that the quenching area for the filaments is sealed, and the quench air stream is accelerated, thus inducing more effective entrainment of the filaments into the air stream. In one type of Reifenhauser system, a so-called “Reicofil 2” line, the acceleration of the air is the result of the combined use of a pressurized quenching chamber and the draw induced by vacuum created beneath the chamber. In other systems, such as represented by a so-called “Reicofil 3” line, two sides of a narrowed section are pressurized, a pressure differential induced by two separate chambers acts to increase the velocity of the air stream in the drawing/quenching section. In such a pressure differential system, the draw is independent of the vacuum created by a co-associated forming box.

In the above-described systems, nonwoven fabrics are generally produced using polypropylene resin having a melt flow rating (MFR) of about 25 to 40 grams/minute. Such resins, due to their low viscosity, typically require melt temperatures between about 210° C. and 230° C. in order to extrude the resin through the spinneret.

To obtain a higher level of strength in a nonwoven continuous filament nonwoven fabric, one approach, known to those skilled in the art, has been to shift to a polypropylene resin having a lower melt-flow rate, and thereby, a more viscous resin. A difficulty encountered when making a shift to a resin having a lower MFR is that the lower viscosity requires a higher melt temperature, which in turn results in greater difficulty in the quenching or solidifying of the filaments. The process is, therefore, made much less stable, and requires a reduction in draw force that, deleteriously, results in larger filaments.

U.S. Pat. No. 5,858,293, hereby incorporated by reference, contemplates that improved fabric strength can be achieved with a polypropylene resin having an MFR between 3 and 30, when stabilized with specific blend of melt additives. It is noted that the examples given in this patent show only a relatively modest increase in strength, in the range of 15% to 18% for grab tensile strength, when compared to the results obtained with a typical 38 MFR spunbond grade polypropylene resin. In these examples, the low MFR resin was processed at a throughput of only 0.35 grams/hole/minute, and the fiber velocity is calculated to be less than 750 meters/minute at the end of the draw zone, based on a denier measurement of 4.4. This low through-put suggests that a low draw force was required to maintain stable processing conditions, which in turn, results in the modest gain in fabric strength.

U.S. Pat. No. 5,667,750 and No. 5,744,548, both hereby incorporated by reference, also relate to attempts to use lower MFR polypropylene resin blends. The resin blend comprises a first polymer having an MFR between 1 and 18, and a second polymer having an MFR between 18 and 30. This blend is taught to produce an increase in tensile strength. It is noted that these patents do not explore the use of a single resin, or the use of a resin having an overall MFR less than 18.

U.S. Pat. No. 5,888,438 contemplates production of a finite-length staple fiber from a blend of polymers, the first polymer having an MFR from 0.5 to 30, and a second polymer having an MFR from 60 to 1000. The use of such a blend is considered to be limiting due the difficulty of blending resins of such different MFR. Additionally, the drawing of the filaments is done mechanically, and is not typical of the process conditions required for the continuous formation of continuous filament nonwoven fabric.

An unmet need exists for a process for continuously spinning a single polypropylene resin into a continuous filament nonwoven fabric, which does not compromise or complicate the use of commercially available continuous filament spinning equipment.

### SUMMARY OF THE INVENTION

The present invention is directed to a process for producing continuous filament nonwoven fabric which comprises the steps of providing a single polymeric resin having an MFR of between about 6 to 16, spinning said single polymeric resin using commercially available continuous filament spinning equipment, to yield a continuous filament nonwoven fabric exhibiting a tensile strength improvement of at least 30% when compared to similar resin of greater than 35 MFR.

The present process further comprises providing a spinneret assembly having a plurality of extrusion holes, and elevating the temperature of the polymeric resin to a melt temperature between about 240° C. to 280° C., preferably between about 245° C. and 270° C. The present process further entails extruding the polymeric resin through the holes of the spinneret assembly to form continuous filaments at a rate of about 0.4 to 0.7 grams/hole/minute, more preferably, at a rate of about 0.43 to 0.6 grams/hole/minute. The filaments are thereafter drawn at a rate between about 1200 to 1800 meters/minute, with the filaments collected and consolidated to form a continuous filament nonwoven fabric. The preferred process provides consolidation means comprising application of thermally stabilization, such as by thermal point bonding through the use of cooperating embossing rolls.

The present process desirably produces continuous filament nonwoven fabrics of substantially enhanced strength by using a single polypropylene resin having a viscosity of between about 6 to 16 MFR. It has been discovered that to process resin having an MFR less than 16 requires a specific set of processing conditions to avoid excessive process instability, that can result in the manifestation of filament breakage and entanglement, or “roping”, of filaments while still in the molten state. It has been determined that the standard process conditions required to produce continuous filament nonwoven fabrics using a polymer having an MFR greater than about 18, and more typically having an MFR of 35, are not suitable for polymeric resins employed for practice of the present invention, and typically result in a very unstable process.

The present invention contemplates that use of specific process conditions with a low MFR polypropylene resin, which permits production of a nonwoven fabric having a greater strength than a fabric produced from a standard 35 MFR resin. As noted, the present process contemplates a throughput of 0.4 to 0.65 grams/hole/minute, and preferably a throughput from about 0.45 to 0.6 grams/hole/minute. The process contemplates an average filament speed of about 1200 to 1800 meters/minute, and preferably from about 1400 to 1700 meters/minute at the end of the draw section. The nonwoven fabric formed from the collected filaments is preferably thermally stabilized with calender rolls at a pressure of about 400 to 800 pounds/linear inch, with a roll surface temperature in the range of about 145° C. to 160° C., as measured on the surface of the individual rolls.

Other features and advantages of the present invention will become readily apparent from the following detailed description.

### DETAILED DESCRIPTION

The present invention is directed to a process for producing a continuous filament nonwoven fabric from polymeric resin, preferably polypropylene, wherein the fabric exhibits enhanced strength characteristics in comparison to typical polypropylene spunbond materials. The improved strength characteristics are achieved by employing a single polymeric polypropylene resin having a melt flow rating in the range between about 6 and 16, with processing of this relatively low viscosity resin specifically selected to provide a stable process at commercially acceptable speeds using commercially available equipment. The process allows the production of a polypropylene spunbond using a single resin having an MFR of less than 16, and produces increases of at least 30% in tensile strength when compared to a typical polypropylene spunbond.

In general, continuous filament nonwoven fabric formation involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs are collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

In accordance with the present invention, a polymeric resin is provided having an MFR of about 6 to 16. A spinneret assembly is provided having a plurality of extrusion holes. The polymeric resin is elevated to a melt temperature between about 240° C. to 280° C., more preferably about 250° C. to 270° C., and extruded through the spinneret assembly.

Prior to extrusion, the single polymeric resin can be compounded with various melt-additives, such as thermal stabilizers, colorants, and nucleating agents. A nucleating agent may be specifically compounded to produce a more stable spinning process, and, at equal process conditions, can produce a further increase in strength.

The present invention contemplates that the polymeric resin is extruded through the holes of the spinneret assembly to form filaments at a rate of about 0.4 to 0.7 grams/hole/minute, more preferably at a rate of about 0.43 to 0.6 grams/hole/minute. The filaments are drawn at a rate of between about 1200 to 1800 meters per minute, more preferably about 1400 to 1700 meters per minute. The filaments are collected to form a nonwoven fabric, with the present process contemplating that the fabric is subsequently stabilized by thermal point bonding. Thermal stabilization can be effected with calender rolls at a pressure of about 400 to 800 pounds/linear inch, and at a surface temperature of about 145° C. to 165° C.

It is believed that by the present process, it is possible to produce substantial increase in the tensile strength of a continuous filament, or spunbond, polypropylene nonwoven fabric using a single high viscosity resin with an MFR less than 16. The optimum process “window” involves a substantial increase in melt temperature, and a successful balance between throughput and draw conditions, with little adjustment to the typical calender conditions. In developing the present invention, certain difficulties were encountered in connection with quenching the filaments, as a result of the lower crystallization speed of the high molecular weight polymer used combined with high processing temperature. This was resolved by reducing both the throughput and the draw air to reduce the filament velocity. During development, it was not apparent that at such melt temperatures the polymer degradation for the high-viscosity polymer would be somewhat equivalent to standard resin degradation. This finding is important to effective spinning as such degradation is detrimental to the development of high fabric strength.

### EXAMPLES

### Example 1

An STP Ampianti line, based on the above-described Lurgi process, was employed to produce a conventional polypropylene continuous filament nonwoven fabric. The line was configured with a double-spinneret beam configuration fed by a single extruder, and with an approximate width of 3.2 meters. Test data, set forth in the accompanying Table 1, exhibits the typical process conditions and properties for a conventional 85 grams/meter² polypropylene spunbond fabric made of commercially available resin having an MFR of 35.

### Example 2

A spunbond fabric made in accordance with the present invention from a single polypropylene resin as supplied by Aristech DPO80C and having an MFR of 8, utilizing the STP Ampianti line as described in Example 1. The resin was run as received from the supplier and did not include the addition of other melt additives or thermal stabilizers.

### Example 3

A Reifenhauser Reicofil 3 processing line, as previously described, was employed to produce a conventional polypropylene continuous filament nonwoven fabric. For this test, a double spinneret beam having a width of 4.2 meters was used. Process conditions and properties for an 85 grams/meter² polypropylene spunbond fabric are reported in Table 1.

### Example 4

A Reifenhauser Reicofil 3 processing line was used to produce a continuous filament nonwoven fabric from a polypropylene resin having an MFR of 8 grams/second. Table 1 sets forth process conditions and properties for the fabrication of this material. The resin blend for the 8 MFR resin included only a color and UV concentrate, with rheology adjusted to match the resin. For this material, a single spinneret was used on the same line as used for the Example 3. The surface temperature of the embossed rolls of the extruder was measured to be between 149 and 151° C. The surface of the smooth roll was 2-3° C. lower. These calender surface temperatures were arrived at by establishing a bonding curve and defining the point that produce the highest tensile strength.

It will be noted that grab tensile strength referred to herein were tested in accordance with the method described by ASTM D-5034. Strip tensile strength refers to the method D882, whereby a jaw separation of 102 millimeters and a cross-head speed of 51 millimeters/minute are used.

The melt flow rate (MFR) is measured by the standard method as specified in ASTM D1238-82, wherein the polymer is, extruded through a capillary at 190° C., under a load of 2.16 Kg, and measured in grams/minute.

The term “machine-direction” (or MD) refers to the direction, which is the same as the direction of motion for the nonwoven web during its preparation. The cross-direction (or CD) is therefore the direction perpendicular to the machine-direction.

The denier of the filament was measured by a microscopic analysis, assuming the typical density for the polypropylene. The filament speed is calculated based on the final circumference of the filament, the polymer density, and the throughput.

As is evident in Table 1, the nonwoven fabrics embodied by the present invention (Example 2 and Example 4) exhibit pronounced strength improvements per basis weight of material as compared to conventional 35 MFR polypropylene spunbond. Specifically, the low MFR materials have a strip tensile strength per unit basis weight of greater than 51.3 grams-force per centimeter per grams per square meter in the machine direction (MD) and 47.1 grams-force per centimeter per grams per square meter in the cross direction (CD).

It is believed that a desirable aspect of the present invention is the ability to produce continuous filament nonwoven fabric made of polypropylene exhibiting significantly increased strength, while using standard commercially available equipment. This desirably results in increasing the value of such equipment, while allowing for the production of high strength fabric more economically. Such fabric can readily be used in applications such as furniture, bedding, construction, construction barriers (i.e. “housewrap”), protective apparel, agricultural fabrics, packaging material, and numerous other applications where strength is an important attribute. A benefit of such fabric is to offer a higher ratio of strength per unit area, allowing a reduction in weight. This reduction is weight with improved strength is particularly beneficial for fabrics which must resistant to handling during application, such as roofing fabrics, housewraps, geotextiles, and the like.

From the foregoing, it will be observed that numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

TABLE 1

| Process Conditions | | | | |
|---|---|---|---|---|
| And Properties | Example 1 | Example 2 | Example 3 | Example 4 |
| Polymer MFR | 35 | 8 | 35 | 8 |
| PROCESS: | | | | |
| Through-put g/hole/min | 0.72 | 0.55 | 0.73 | 0.47 |
| Extruder temperature in | 220 | 245 | 215 | 270 |
| the last zone ° C. | | | | |
| Spinnerets | 207 | 243 | 230 | 270 |
| temperature ° C. | | | | |
| Melt temperature ° C. | 217 | 250 | 230 | 275 |
| Quench air | 45 | 45 | 17 | 17.5 |
| temperature ° C. | | | | |
| Draw air volume m3/h | | | 21500 | 14500 |
| Filament speed at the end | 2817 | 1650 | 3285 | 1627 |
| of the draw section | | | | |
| m/min | | | | |
| Calender bonding | 600 | 640 | 450 | 500 |
| pressure PLI | | | | |
| Calender set point | 174 | 181 | 175 | 175 |
| for the embossed | | | | |
| roll ° C. | | | | |
| Calender set point | 175 | 185 | 155 | 165 |
| for the smooth roll | | | | |
| ° C. | | | | |
| PROPERTIES | | | | |
| Basis weight g/m² | 85.0 | 87.0 | 85.0 | 91.0 |
| Fiber size, denier | 2.0 | 3.0 | 2.0 | 2.6 |
| Grab tensile strength | 46/46 | | 51/40 | 79/69 |
| MD/CD lb/in | | | | |
| Strip tensile | 3214/2857 | 4464/4107 | 2589/1821 | 5715/4286 |
| strength MD/CD | | | | |
| grams/cm | | | | |
| Strip tensile strength/ | 37.8/33.6 | 51.3/42.7 | 30/47/21.4 | 62.8/47.1 |
| Basis Weight | | | | |

1. (canceled)

2. (canceled)

3. (canceled)

4. (canceled)

5. (canceled)

6. (canceled)

7. A continuous filament nonwoven fabric, comprising a polypropylene resin having an MFR of about 6 to 16, said nonwoven fabric having a minimum MD and CD Strip Tensile Strength per unit basis weight of at least 47.1 grams-force per centimeter per gram per square meter.

8. A continuous filament nonwoven fabric, consisting of a polypropylene resin having an MFR of about 6 to 16, and at least one melt additive, said nonwoven fabric having a minimum MD and CD Strip Tensile Strength per unit basis weight of at least 47.1 grams-force per centimeter per gram per square meter.
